(19) United States
(12) Patent Application Publication
(10) Pub. No.: US 2022/0185729 A1
(43) Pub. Date: Jun. 16, 2022

(54) Novel Cellulose-Based Concrete Mix and Processes

(71) Applicant: Joshua Allen McGuire, Lake Charles, LA (US)

(72) Inventor: Joshua Allen McGuire, Lake Charles, LA (US)

(21) Appl. No.: 17/687,552

(22) Filed: Mar. 4, 2022

Related U.S. Application Data
(60) Provisional application No. 62/156,920, filed on May 5, 2015.

(51) Int. Cl. C04B 18/24; C04B 28/02; C04B 14/06; C04B 18/02

(52) U.S. Cl. CPC C04B 18/24; C04B 18/021; C04B 14/06; C04B 28/02

(57) ABSTRACT

A construction material comprising a cellulose material impregnated with cementitious particulates, a cellulose material impregnated with cementitious particulates, cement, and sand, a cellulose material impregnated with cementitious particulates, cement, sand, and stone, and manufacturing processes thereof are described.

### RELATED APPLICATION

The present patent application claims the benefit of U.S. Provisional Application No. 62/156,920 filed on Mar. 4, 2021, which is incorporated herein by reference in its entirety.

### FIELD

The present disclosure relates generally to construction materials and processes, and in particular to a novel cellulose-based concrete mix and processes for use in construction.

### BACKGROUND

Conventional concrete is a composite material composed of fine and coarse aggregate (typically sand and gravel) bonded together with a fluid cement that hardens or cures over time. Portland cement is the most common type of cement in general use around the world as a basic ingredient of concrete, mortar, stucco and non-specialty grout. Concrete is one of the most frequently used building materials. Its usage worldwide, ton for ton, is twice that of steel, wood, plastics, and aluminum combined. Globally, the ready-mix concrete industry, the largest segment of the concrete market, is projected to exceed $600 billion in revenue by 2025.

### BRIEF DESCRIPTION OF THE DRAWINGS

FIGS. 1-4 are flowcharts of an exemplary embodiment of a manufacturing process of a lightweight cellulose-based aggregate-like product and a concrete-like product according to the teachings of the present disclosure; and

FIGS. 5 and 6 are various views of exemplary embodiments of processed cellulose fibers and “aggregreat” mix product for the cement mixture bags according to the teachings of the present disclosure.

### DETAILED DESCRIPTION

A lightweight recycled cellulose-based aggregate-like and concrete-like products described herein can be utilized in construction and to fabricate building components. The resultant product produces a structure that is thermally insulative and fire-retardant. The cellulose-based concrete may be used to create building components such as bricks, blocks, panels (i.e., oriented strand board and plywood substitutes), posts, columns, beams, foundations, walls, and other types of structural components and supports. The cellulose-based concrete can be poured on-site or used for fabrication off-site, and not only yields lightweight insulative, fire-proof, and anti-ballistic construction products but also substantially reduces costs and offset the carbon footprint of a construction project. For every two pounds of wood byproduct that is incorporated into the admix, one pound of carbon is permanently removed from the atmosphere and sequestered.

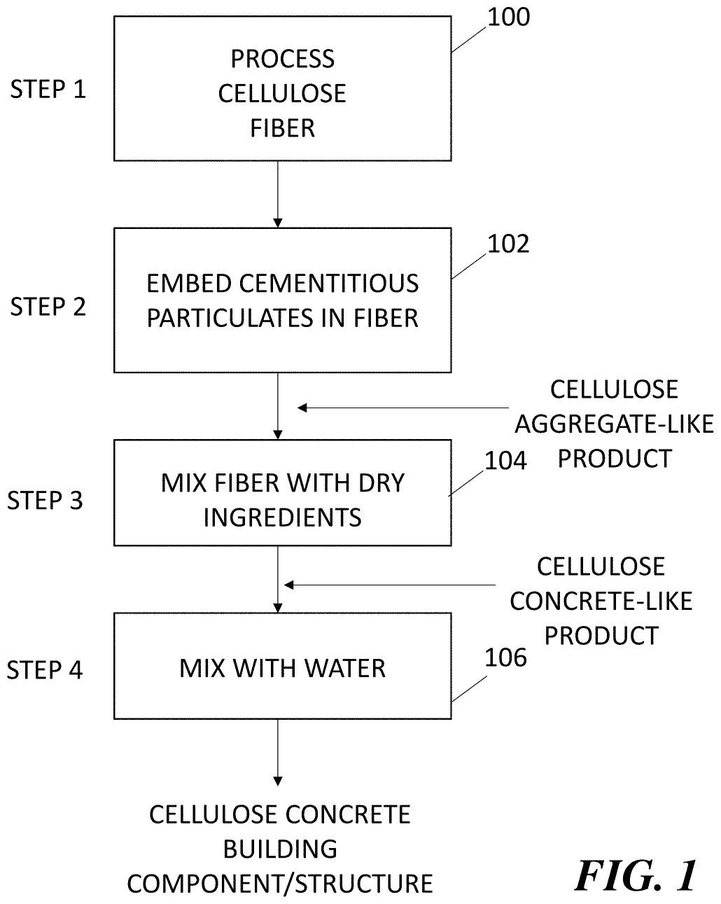

Referring to FIG. 1, the method has three main steps: processing the organic cellulose material 100, which is an organic cellulose material of certain sizes that can be as small as microscopic particles and as large as an entire tree, including sawdust, wood chips, wood flakes, wood strips, fiber, bamboo, hemp, burlap, tweed, organic waste, and animal waste both liquid and solid form. The next step 102 is to embed cementitious particulates in the processed cellulose fiber. At the end of the second step 102, an “aggregreat” mix product is produced. The third step 104 is to mix the aggregreat product, which is cellulose fibers with embedded cementitious particulates, with other dry ingredients. At the end of the third step 104, an “aggrecrete” mix product is produced. This “aggrecrete” mix product can be used like a concrete mix that can then be mixed with water (step 4 106) that can then be added forms, molds, and other devices to create cellulose-based concrete products that have far superior properties than conventional concrete materials.

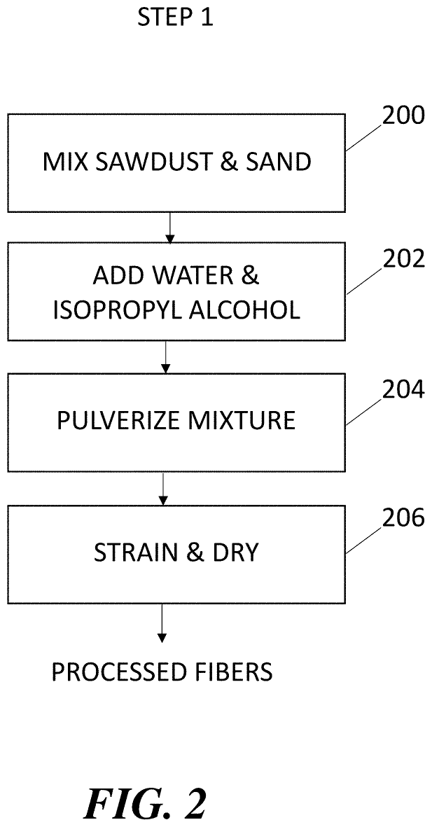

FIG. 2 is a flowchart that provides a more detailed STEP 1 process for creating the processed cellulose fibers. Cellulose materials in the form of sawdust or other organic materials are mixed with sand 200. An example ratio of these materials may be one part sand to 1.5 part sawdust. An appropriate amount of water and an appropriate amount of isopropyl alcohol are added to the dry mix 202. The combined mixture is then blended and pulverized so that the cellulose fibers are a certain size 204. The end product is then strained and dried 206. The resultant product is a dry processed fiber mix.

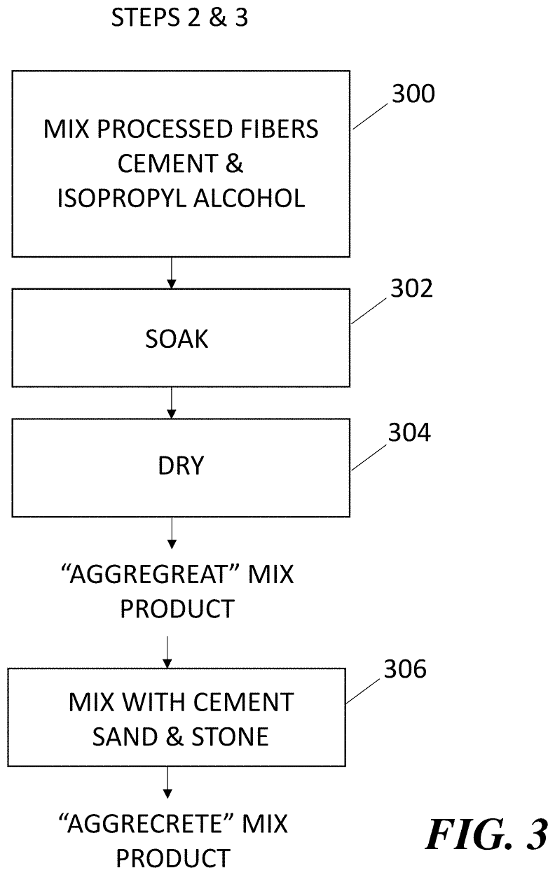

FIG. 3 is a flowchart that provides a more detailed STEPS 2 and 3 processes for creating the “aggregreat” mix product and the “aggrecrete” mix product. This is the process that embeds cementitious particulates into the processed fiber. A certain amount of processed fiber is combined with cement (e.g., Portland cement), and the mix is saturated with isopropyl alcohol 300. This mixture is mixed thoroughly and allowed to sit for a predetermined amount of time, such as 1-2 hours 302. During this time, the isopropyl alcohol is allowed to evaporate until a dry mixture is left 304. This is the “aggregreat” mix product. The “aggregreat” mix product can be sold and used as a substitute for the conventional aggregate product. The “aggregreat” mix product can then be combined with cement and sand and optionally stone (306) to create an “aggrecrete” mix product that can be sold and used as a substitute for the conventional concrete product.

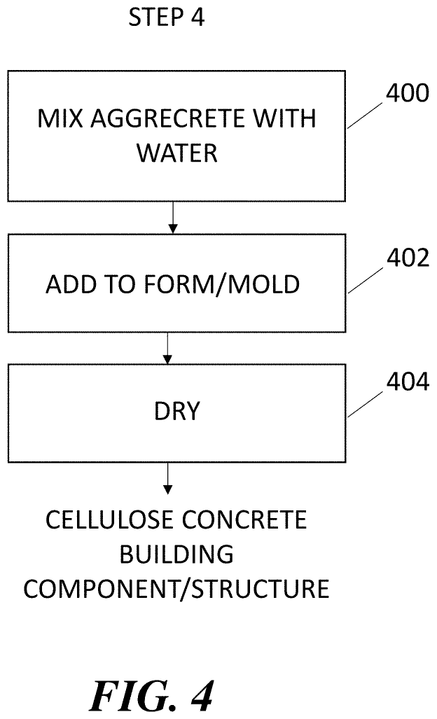

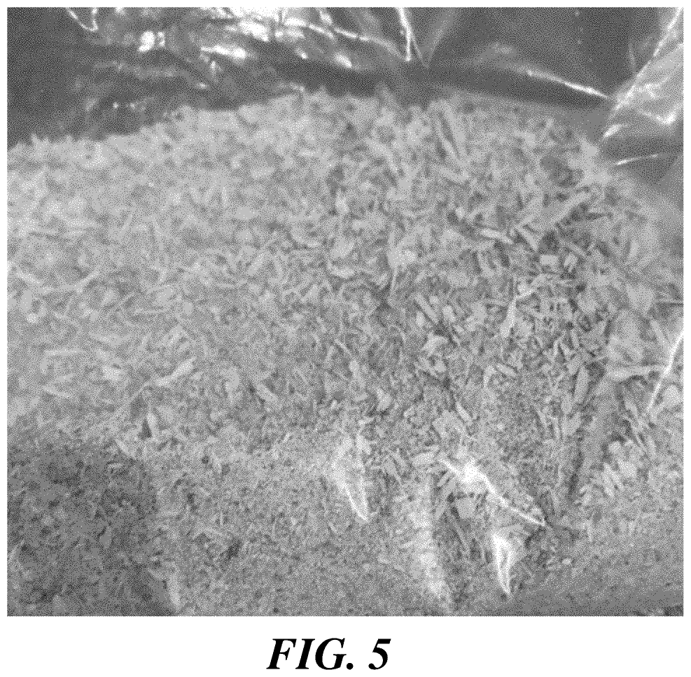

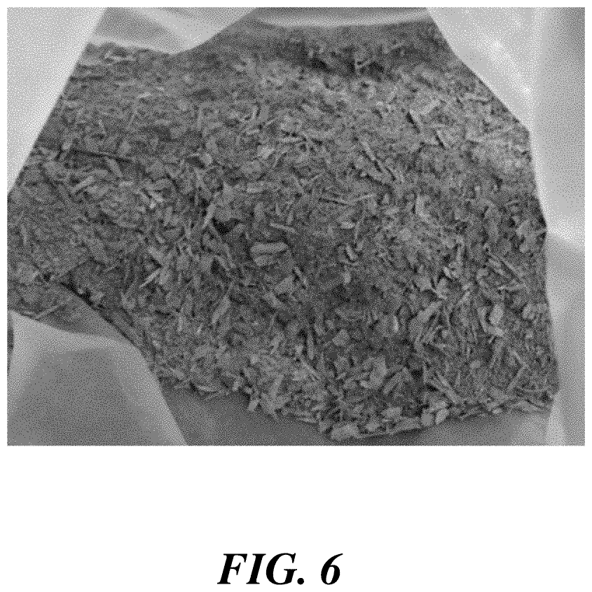

FIG. 4 is a flowchart for a STEP 4 process. The “aggrecrete” mix product is combined with an appropriate amount of water and mixed thoroughly 400. This wet mixture can be added to a form or mold to create a number of building/structural components having a variety of shapes and sizes for construction purposes 402. The mixture is allowed to cure until hard 404.

It has been determined that the use of isopropyl alcohol in STEP 1 and STEP 2 functions to inhibit and retard the exothermic reaction of cement so that the cementitious particulates can thoroughly embed and impregnate within the open structures of the cellulose fibers without hardening even in the presence of water. It also has been determined that controlling the ambient temperature or the temperature of the water and/or isopropyl alcohol to be in the 30-40 F degrees range also achieves the same function of inhibiting or retarding the exothermic reaction of the cement.

The ratios of the various components (cellulose material, sand, cement, and isopropyl alcohol) at various steps can be varied depending on the desired characteristics of the final product. Sawdust is a desirable material to use as it is a waste product of the lumber industry. Green cellulose can be air dried or dried with an application of heat (e.g., in a kiln) to remove excess moisture. At various steps the materials can be mixed together using, for example, a paddle mixer to ensure that the fibers are well-saturated, the cementitious particulates are well-dispersed in the mixture (emulsification), and the fibers are well-coated. At any step, the dry ingredients can be mixed together first before adding the wet ingredients, the dry ingredients can be added and mixed successively with a wet ingredient then mixed, or all of the ingredients can be combined and mixed at the same time. The amount of time allowed for thorough saturation, evaporation, and drying depends on various factors.

Additional additive materials that can be added at various steps of the processes include clay, ceramics, graphene, metallic particulates, semi-metallic particulates, diatomaceous earth, crystalline expander, carbon-based materials, sand, silt, peat, loam, chalk, fly ash, recycled paper, phosphate, lime, calcium, magnesium, sugars, lignin, vegetable and animal proteins, cotton, almond flour, coconut flour, buckwheat flour, teff flour, quinoa flour, corn flour, wheat flour, barley flour, rice flour, rye flour, tree sap, syrup, sugars, tars, nut shells and husks, corn husks, grass clippings, any by product from the production of rice, wheat, and other grain, ethylene glycol derivatives, ionic water, salt, acids, alkaline, alcohol, bleach, and biodegradable surfactants (including H2).

The features of the present invention which are believed to be novel are set forth below with particularity in the appended claims. However, modifications, variations, and changes to the exemplary embodiments of the novel cellulose-based admix and process for fabricating lightweight insulative fire-retardant building structural components described above will be apparent to those skilled in the art, and the described herein thus encompasses such modifications, variations, and changes and are not limited to the specific embodiments described herein.

What is claimed is:

1. A construction material comprising a cellulose material impregnated with cementitious particulates.

2. The construction material of claim 1, further comprising a cellulose material impregnated with cementitious particulates, cement, and sand.

3. The construction material of claim 1, further comprising a cellulose material impregnated with cementitious particulates, cement, sand, and stone.

4. A manufacturing process for a construction material comprising the steps of:
mixing a predetermined amount of sawdust with a predetermined amount of sand;
adding a predetermined amount of water and a predetermined amount of isopropyl alcohol to create a wet mixture;
mixing and pulverizing the mixture thoroughly;
drying the mixture and producing processed fibers;
adding a predetermined amount of cement;
adding another predetermined amount of isopropyl alcohol;
mixing the processed fibers with the cement and isopropyl alcohol;
allowing the processed fibers to be thoroughly coated and saturated;
drying the mixture and producing an aggregate-like product;
adding a predetermined amount of sand;
adding another predetermined amount of cement; and
thoroughly mixing the aggregate-like product with the sand and cement and producing a concrete-like product.

5. The process of claim 3, wherein thoroughly mixing the aggregate-like product further comprises adding stone to the mix.

6. The process of claim 3, further comprising the step of adding at least one additive selected from the group consisting of clay, ceramics, graphene, metallic particulates, semi-metallic particulates, diatomaceous earth, crystalline expander, carbon-based materials, sand, silt, peat, loam, chalk, fly ash, recycled paper, phosphate, lime, calcium, magnesium, sugars, lignin, vegetable and animal proteins, cotton, almond flour, coconut flour, buckwheat flour, teff flour, quinoa flour, corn flour, wheat flour, barley flour, rice flour, rye flour, tree sap, syrup, sugars, tars, nut shells and husks, corn husks, grass clippings, any by product from the production of rice, wheat, and other grain, ethylene glycol derivatives, ionic water, salt, acids, alkaline, alcohol, bleach, and biodegradable surfactants.

7. A manufacturing process for a construction material comprising the steps of:
mixing a predetermined amount of sawdust with a predetermined amount of sand;
adding a predetermined amount of water to create a wet mixture;
mixing and pulverizing the mixture thoroughly;
drying the mixture and producing processed fibers;
adding a predetermined amount of cement;
adding a predetermined amount of isopropyl alcohol;
mixing the processed fibers with the cement and isopropyl alcohol;
allowing the processed fibers to be thoroughly coated and saturated;
drying the mixture and producing an aggregate-like product;
adding a predetermined amount of sand;
adding another predetermined amount of cement; and
thoroughly mixing the aggregate-like product with the sand and cement and producing a concrete-like product.

8. The method for producing a new construction material as set forth in claim 7, further comprising the step of adding an appropriate amount of a liquid and mixing to produce a slurry mix that can be molded and/or poured into a form.
